(19) United States
(12) Patent Application Publication
(10) Pub. No.: US 2008/0209333 A1
(43) Pub. Date: Aug. 28, 2008

(54) Method and apparatus for visualizing a network

(75) Inventor: Randall Wayne Frei, San Jose, CA (US)

Correspondence Address: RAYMOND R. MOSER JR., ESQ.;MOSER IP LAW GROUP, 1030 BROAD STREET, 2ND FLOOR, SHREWSBURY, NJ, 07702, US

(73) Assignee: SkyPilot Networks, Inc., Santa Clara, CA (US)

(21) Appl. No.: 11/710,327

(22) Filed: Feb. 23, 2007

(51) Int. Cl. G06F 15/177

(52) U.S. Cl. 715/736

(57) ABSTRACT

A visualization tool for displaying the geographic location and connectivity of nodes within a network. More specifically, a method and apparatus determines a geographic position of each node in a plurality of nodes within a data network; determines an icon to represent each node in the plurality of nodes; overlays each of the icons onto a geographically accurate map, where each icon is position at the geographic position for the node represented by the icon; determines node connectivity; and overlays, upon the geographically accurate map, a graphical link between pairs of icons representing node connectivity. In this manner, a network operator is provided a geographically accurate view of a data network including nodes and the connectivity of the nodes.

### BACKGROUND OF THE INVENTION

1. Field of the Invention

The present invention relates to data networks and, more particularly, to a method and apparatus for visualizing the nodes and interconnections of a data network.

2. Description of the Related Art

Modern data networks are complex and very large. Network management tools generally provide a graphical view of the communication links and the quantity of data that is communicated from node-to-node within a network. The positioning of nodes within a graphical view is generally performed manually and is not completely correlated with the actual physical location of the nodes to any particular coordinate system.

In wireless systems, where the nodes may be moved and/or are regularly altered, the connectivity between nodes and the actual physical position of the node is generally unknown. As a result, a graphical visualization tool generally produces inaccurate views of the network and, at best, when such views are created using a manual process, the views are updated in a delayed fashion. As such, a network operator is not provided with a real time view of node location and connectivity within a particular network.

Therefore, there is a need in the art for a network visualization tool that allows an operator to display a network in real time with the nodes positioned in a graphical manner in their actual geographic locations.

### SUMMARY OF THE INVENTION

The present invention is a visualization tool for displaying the geographic location and connectivity of nodes within a network. More specifically, the method and apparatus determines a geographic position of each node in a plurality of nodes within a data network; determines an icon to represent each node in the plurality of nodes; overlays each of the icons onto a geographically accurate map, where each icon is position at the geographic position for the node represented by the icon; determines node connectivity; and overlays, upon the geographically accurate map, a graphical link between pairs of icons representing node connectivity. In this manner, a network operator is provided a geographically accurate view of a data network including nodes and the connectivity of the nodes.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a network and the visualization tool used to display the network to users or operators in accordance with the present invention;

FIG. 2 is a flow diagram of a method of formatting node information and position used by the visualization tool;

FIG. 3 depicts a flow diagram of a method of creating a display using the visualization tool;

FIG. 4 depicts a high-level view of a network displayed within the visualization tool;

FIG. 5 depicts an expanded view of a network displayed within the visualization tool; and

FIG. 6 depicts a node information that is displayed upon manipulation of the visualization tool.

### DETAILED DESCRIPTION

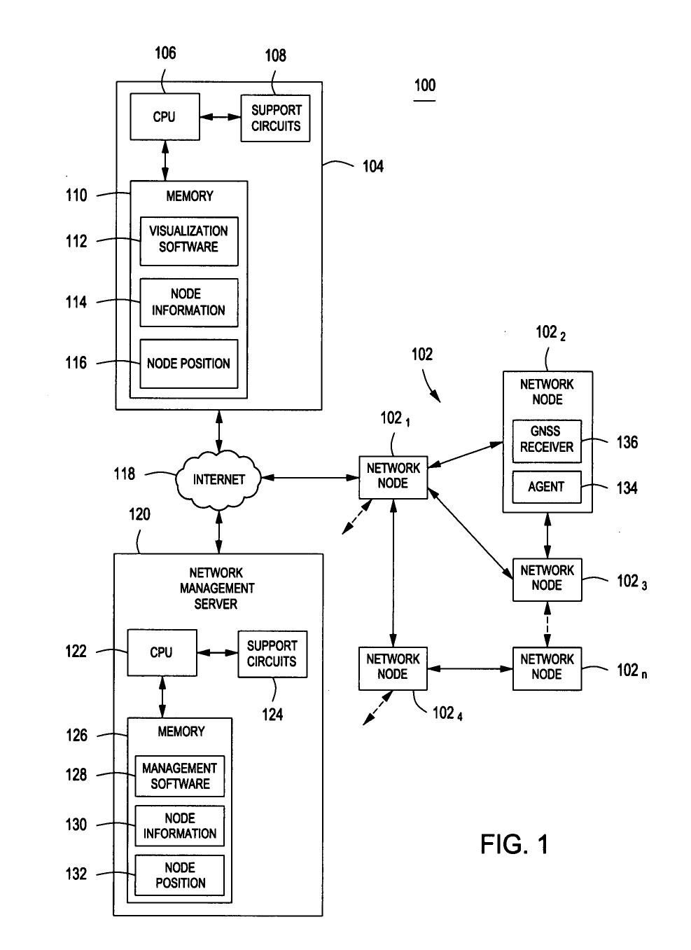

FIG. 1 depicts a communications network 100 comprising a visualization computer 104, a communications network 102, an interconnection network 118, and a network management server 120. The visualization computer 104 comprises a central processing unit (CPU) 106, support circuits 108, and memory 110. The CPU 106 may be one or more of many available CPUs, processors, or micro-controllers. The support circuits 108 comprise well-known circuits that facilitate the operation of the CPU 106. The support circuits 108 may comprise, for example, clock circuits, power supplies, cache, interface circuits, and the like. The memory 110 may comprise read-only memory, random access memory, flash memory, disk drives, removable memory, and the like. One or more of these memories in combination are used to store various software and data that is used and manipulated by the CPU 106. For support of the current invention, the memory 110 stores visualization software 112, node information 114, and node positions 116. In one embodiment of the invention, the visualization software 112 comprises commercially available software such as GOOGLE EARTH, GOOGLE MAPS, YAHOO MAPS and the like. When using GOOGLE EARTH, the network node information and node positions are provided to the software in a format known as KML, a specific type of eXtensible Markup Language (XML). The information used by the visualization software is provided from the network management server 120 via the communications network 118.

The visualization computer 104 is coupled to a communications network 118 such as the Internet. Through the network 118, the network management server 120 may communicate with the visualization computer 104 to facilitate display of visualization tools upon the visualization computer 104. The network 118 is also connected to the network 102 that is to be displayed by the visualization tool.

The network management server 120 comprises at least one CPU 122, support circuits 124 and memory 126. The CPU 122 comprises one or more microprocessors and/or microcontrollers. The support circuits 124 are well-known circuits that facilitate operation of the CPU 122. The support circuits 124 comprise at least one of power supplies, clock circuits, cache, input/output circuits, network cards and the like. The memory 126 comprises at least one of digital storage devices or circuits such as read only memory, random access memory, disk drives, optical storage, removable storage, and the like. The memory 126 stores management software 128, node information 130 and at least one node position 132. In one embodiment, the management software 128 uses the well-known Simple Network Management Protocol (SNMP) or some other network management tool to manage the network 102. The management software 128 gathers the node information and node positions form the nodes in network 102. The management software 128 then formats this information to facilitate use by the visualization computer 104, e.g., KML format for GOOGLE EARTH.

The network 102 comprises a plurality of network nodes 102₁, 102₂, 102₃, 102₄, . . . 102_{N} (where N is an integer greater than 0). These nodes together comprise the network 102. Generally, this network is a wireless network such as a mesh network provided by SkyPilot Networks Inc. of Santa Clara, Calif. Typically, the network nodes communicate data with one another in a manner described in, for example, U.S. Pat. No. 7,149,183, issued Dec. 12, 2006 and U.S. Pat. No. 7,113,519, issued Sep. 26, 2006 which are incorporated herein by reference in their entirety.

In one embodiment, each network node 102_{N} comprises a global navigation satellite system (GNSS) receiver 136. The GNSS receiver 136 uses satellite signals to compute the position of the network node 102_{N}. This position of the network node 102_{N} is communicated through the network 102 to the Internet 118 and finally to the network management server 120. In other embodiments, the location coordinates for the node location may be determined and manually recorded either in the node or in the server 120 during installation of the node. In still another embodiment, the location of the node may be determined using a signal timing technique, antenna sector or signal triangulation techniques and the like. One type of signal timing technique is described in commonly-assigned U.S. patent application Ser. No. 11/311,452, filed Dec. 19, 2005 (Attorney Docket SKY/014) and incorporated by reference herein in its entirety.

The network management server 120 stores the network position information 130 in memory 126. Additionally, the network nodes 102_{N} communicate certain node information to the server 120 for storage in the memory 126 as node information 114.

Thus, the network 102 comprising network nodes 102_{N} sends node position and node information through the network 118 (e.g., an Internet Protocol (IP) Network) to the server 120 for storage therein. The visualization computer 104 accesses the network management server 120 through, for example, the Internet (network 118) to display the node information and the node positions in a graphical interface upon the visualization computer 104.

In an alternate embodiment, the individual network nodes 102₁ . . . 102ₙ comprise visualization agent software 134 that creates appropriately formatted node information and node position that is communicated directly to the visualization computer 104 and stored therein as node information 114 and node position 116. In one embodiment, the visualization agent software 134 formats the node information and node position in KML format for display by GOOGLE EARTH.

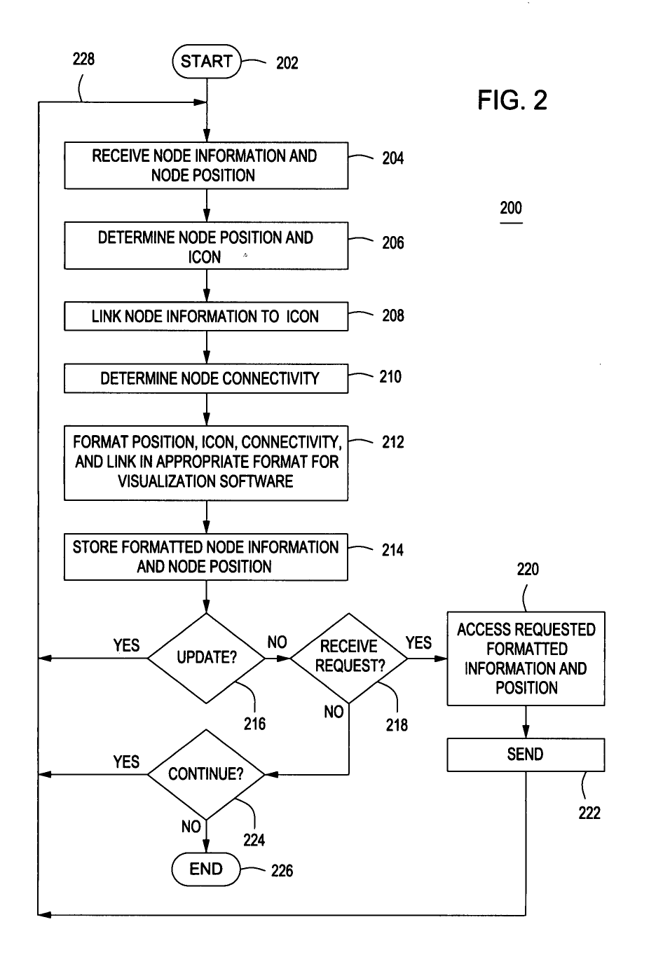

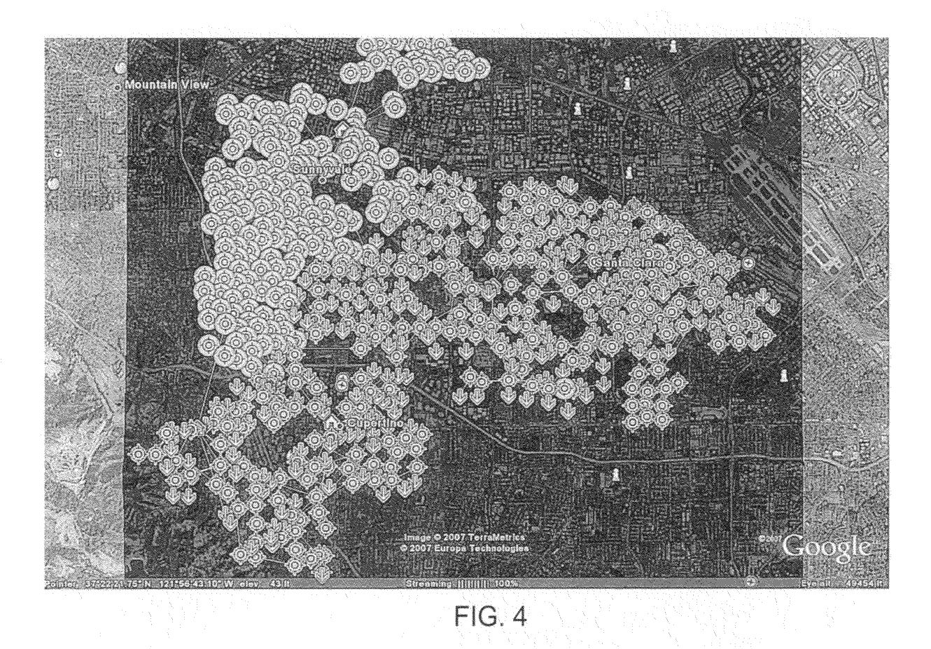

FIG. 2 depicts a flow diagram of a method 200 for formatting information for a user interface (as depicted in FIGS. 4, 5, and 6) using the network management server 120. The method 200 begins at step 202 and proceeds to step 204, wherein the node information and node position is received from the nodes of network 102. Such information may be provided in response to polling or on a periodic schedule. At step 206, the method 200 determines an icon representing the node and a geographic position for the node. The icon may be one of several types of icons depending on the type of node that is being displayed. The node may be a user node (e.g., customer premises equipment (CPE)) that is located at a user home or business. The user's local network connects directly to the CPE to access data and the Internet. User nodes may communicate with one another as well as communicate to extender nodes. The extender nodes communicate with each other to provide a mesh network. The mesh network is coupled to a mesh gateway that communicates with a wired network. Each of the node types—CPE, extender and gateway—are displayed using a unique icon.

Although a mesh network is discussed as one exemplary network embodiment that can be visualized using the present invention, the present invention may also be used to visualize point-to-multi-point and point-to-point networks. In fact, the current invention may be used for any network where the geographic position of the nodes are available to the visualization computer.

In the present invention, the positions are provided by a GNSS receiver, such as a GPS receiver, a GLONASS receiver, a Galileo receiver and the like. Other position location techniques could be used such as triangulation, manually entered position coordinates, antenna sector direction, over-the-air timing, and the like.

At step 208, the method 200 links the node information to the icon representing the node (e.g., using an HTTP link). At step 210, the method 200 determines node connectivity. The node connectivity is generally contained in the node information supplied by a node. The node connectivity identifies the neighboring nodes to which a particular node is presently connected. This connectivity information is used to graphically display interconnections between nodes.

At step 212, the position, icon, connectivity, and link information are formatted into an appropriate data format for use by the visualization software. In one embodiment, the information is formatted using KML when the visualization software is GOOGLE EARTH. For use with GOOGLE MAPS or YAHOO MAPS, the information is formatted using XML. Other formats for other forms of visualization software may be used.

At step 214, the method 200 stores the formatted node information and node position (collectively referred to herein as formatted information). At step 216, the method 200 queries whether the formatted information requires updating. If an update is needed, the method continues along path 228 to step 204. If no update is needed, the method proceeds to step 218. Updating the formatted information may occur in accordance with a schedule, periodically, in view of an aging plan, and the like.

At step 218, the method 200 queries whether a request for the formatted information has been received. If a request has not been received, the method proceeds to query step 224, wherein the method 200 queries whether the process should continue. If affirmatively answered, the method 200 proceeds along path 228 to step 204; otherwise, the method 200 ends at step 226.

If a query step 228 is affirmatively answered, the method 200 proceeds to step 220 to access the requested formatted information. At step 222, the formatted information is sent via the communications network to the visualization computer. Generally, the formatted information is sent using TCP/IP.

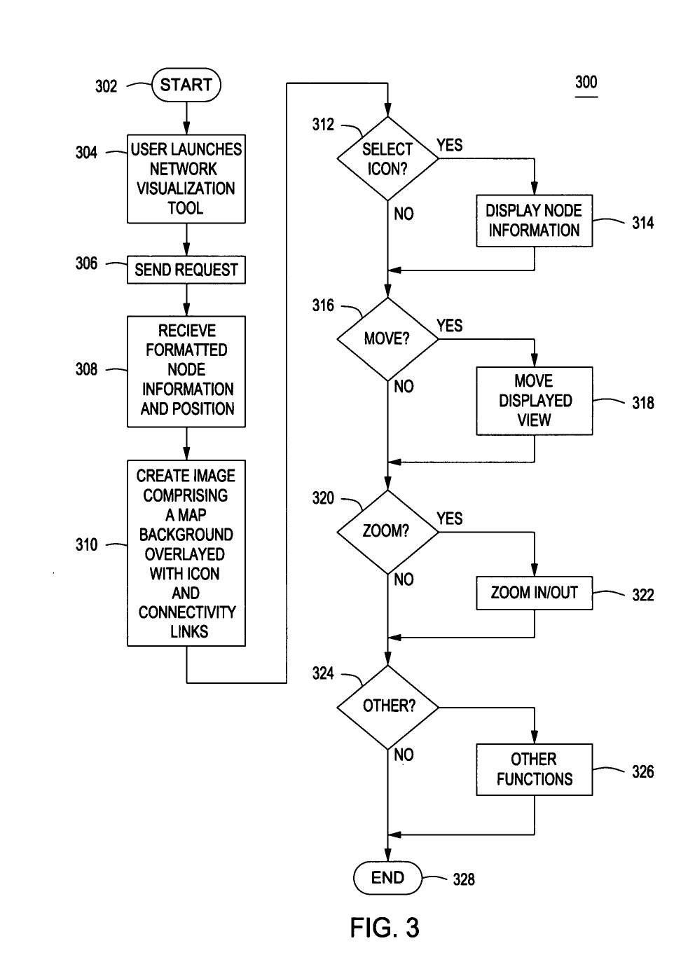

FIG. 3 depicts a flow diagram of the method 300 for graphically displaying a network in accordance with one embodiment of the invention. The method 300 begins at step 302 and proceeds to step 304. At step 304, a user launches the network visualization tool, i.e., executes the visualization software 112 of FIG. 1. Launching the tool may occur within an HTML page, wherein selection of a tool icon launches the tool and automatically performs steps 306 to 310 as described below.

At step 306, the method 300 sends a request to the network management server 120 to request formatted information. The request may specify a particular network, or a network or networks in a specific geographic region. At step 308, the method 300 receives the formatted information.

At step 310, the method 300 creates an image for display that comprises a map background overlayed with at least one icon and at least one connectivity link. The visualization software uses the formatted information to overlay icons and geographic connections onto a map, where placement of the icons and connections are geographically accurate as defined by the node position contained in the formatted information. For example, GOOGLE EARTH uses the KML formatted information to overly the icons and connections onto a satellite image (map).

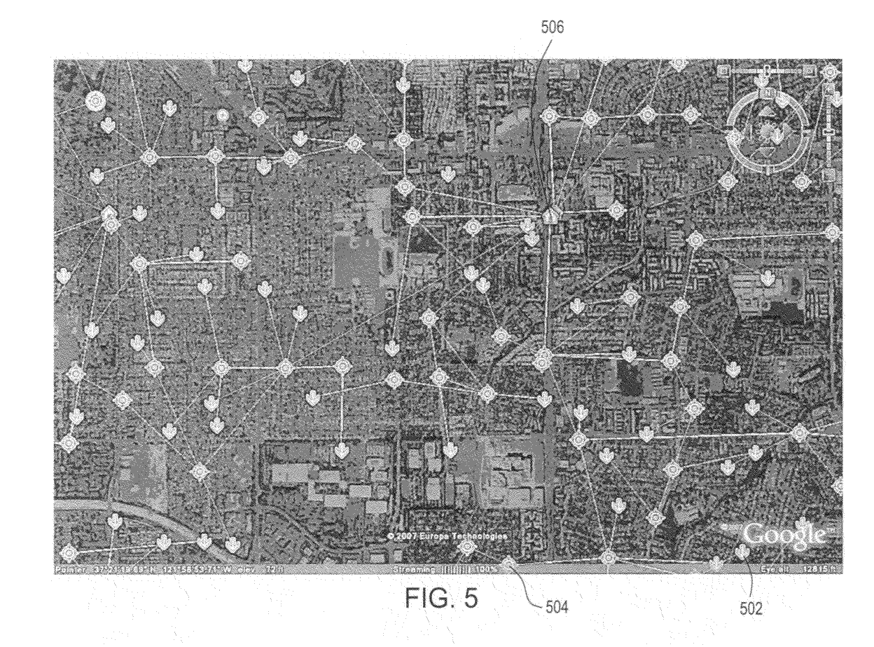

Upon completion of the map and its overlays, a display is created of all of the nodes within the network and their interconnections. FIG. 4 depicts just such a densely populated network, wherein, a high-level image shows all of the different types of nodes within multiple networks that are positioned on the visualization image. In this embodiment, the map is a satellite image of a portion of the earth. When the image is zoomed upon, FIG. 5 is created, wherein, the individual nodes and their interconnections can be seen clearly on the map. The icons 502 represent end-users e.g., CPEs, the icons 504 represent extender nodes and icon 506 represents a gateway node. The extender nodes are connected to one another to provide redundant traffic pathways through the network to the end-user nodes. Gateway nodes 506 are depicted to show the locations where the network is connected to the internet backbone.

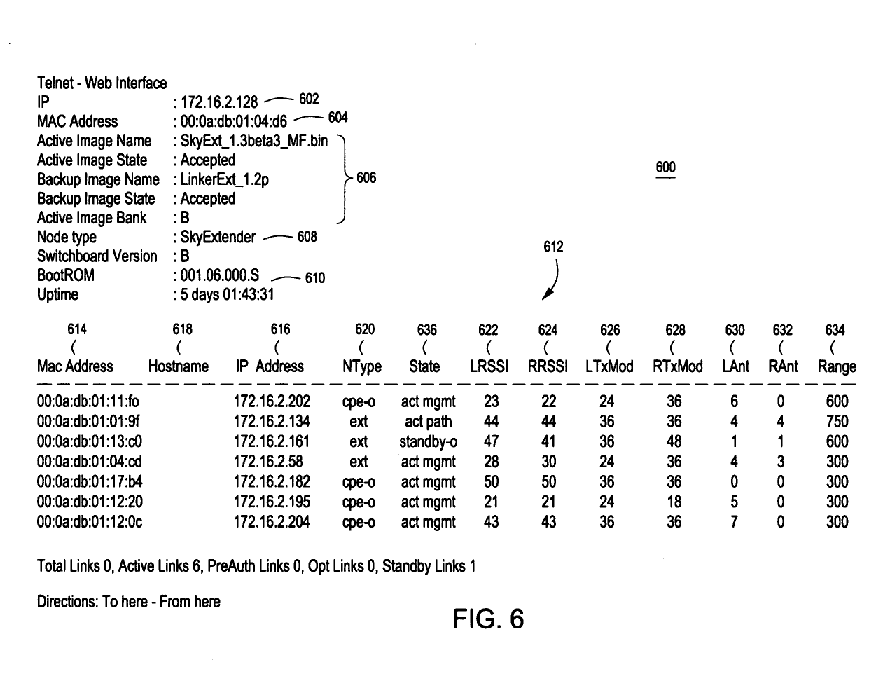

In one embodiment, the overlay and its underlying image are displayed in a manipulable graphical interface. As depicted in FIGS. 4 and 5, the user has a number of options within the interface, which are not listed in any particular order within the method 300. The user may select a particular icon, manipulate the imagery by moving the view, zoom in or out on the imagery, or perform other functions. At step 312, the user may select an icon. If an icon is selected, the node information for the selected icon will appear (at step 314) in a pop-up box or a side box within the graphical interface. For an example of such a display, see FIG. 6 and the accompanying text below. At step 316, the user may grasp the graphical interface and move the interface in an up, down, left, right or diagonal direction. At step 318, such manipulation is performed within the display. At step 320, the user may select to zoom in or out upon the depicted graphics. If a zoom function is selected, the method 300 proceeds to step 322 wherein the image is zoomed in or out to provide varying details of the network. At step 324, the user may select other functions. If other functions are selected, the method 300 proceeds to step 326 to facilitate implementing the other display functions. At step 328, the user may select to close the graphical user interface and discontinue use of the visualization tool.

Upon each manipulation, the method 200 of FIG. 2 may be performed to update the information within the display. Alternatively, periodic updates may be performed (upon periodic request from method 300) to ensure that the display contains current network structure and information.

FIG. 6 depicts the information that one embodiment of the node information that may be displayed when a node is selected. This information includes the IP address 602 of the node, the Mac address 604 of the node, various image information 606 that is used in network administration, the node type 608 (whether it is an extender, an end-user or gateway node), how long the node has been active (up time) 610, and various information 612 about the communications for that particular node. The list of communication information 612 comprises the various MAC and IP addresses 614, 616 of the nodes that are in communication with the currently displayed node. The information 612 also comprises the host name 618, if any, the node type 620 of each node that is communicating with the selected node, the state 636 of that node, the relative signal strength 622, 624 of the communications between the nodes for each of the left and the right antennas of the node, local and remote modulation 626, 628 and the range 634 between the nodes, amongst other information. In this matter, the user can instantly be advised of the status and current utilization of a particular node within the network.

In addition, the information of FIG. 6 may include at least one “button” or “link” 636 that, when selected, causes an application to launch. Such an application may be a web browser interface or a telnet session. This software is used to facilitate a connection to the node (for example, via the node's IP address) such that the node can be controlled or enable additional information to be monitored or extracted.

All of the information displayed herein can be utilized within a particular embodiment that uses GOOGLE EARTH as the basis for the visualization tool to display the network nodes and their interconnections. Such information can be displayed because each of the nodes provides the location of the nodes to the visualization computer for generating the display.

The embodiments described above uses a network management server as an intermediary between the visualization computer and the network to be visualized. Alternatively, the nodes of the network may generate formatted information. The visualization computer may either request the formatted information directly from the nodes or the formatted information can be sent periodically from the nodes to the visualization computer. The method for creating the display is not dependent upon the source of the formatted information.

While the foregoing is directed to embodiments of the present invention, other and further embodiments of the invention may be devised without departing from the basic scope thereof, and the scope thereof is determined by the claims that follow.

What is claimed is:

1. A method for visualizing a data network comprising:
determining a geographic position of each node in a plurality of nodes within the data network;
determining an icon to represent each node in the plurality of nodes;
determining node connectivity; and
generating formatted information comprising geographic position, the icon and the node connectivity.

2. The method of claim 1 further comprising linking node information to each icon representing the nodes in the plurality of nodes.

3. The method of claim 2 wherein the node information comprises signal strength of signals to and from neighboring nodes.

4. The method of claim 2 wherein the node information comprises address information for the node and neighboring nodes.

5. The method of claim 1 wherein the step of determining geographic position comprises receiving global navigation satellite system (GNSS) signals at each node and computing a node position from the GNSS signals.

6. The method of claim 5 wherein the GNSS comprises at least one of the global positioning system, GLONASS, and Galileo.

7. The method of claim 1 further comprising combining the formatted information with a geographically accurate map.

8. The method of claim 7 wherein the geographically accurate map comprises a satellite image.

9. The method of claim 1 wherein the icons comprise a different icon for each type of node.

10. The method of claim 9 wherein the type of nodes comprise at least one of customer premises equipment, an extender node and a gateway node.

11. The method of claim 1 further comprising selecting an icon and displaying node information in response to the icon selection.

12. The method of claim 11 wherein the node information is displayed in a pop-up window or side box.

13. The method of claim 11 wherein the node information comprises at least one link or button to launch software to provide an interface to the node.

14. The method of claim 7 further comprising displaying the geographically accurate map with the overlay of icons and graphical links.

15. The method of claim 14 further comprising manipulating the geographically accurate map and the overlay using at least one of a move command and a zoom command.

16. A visualization tool comprising:
a network management server for receiving a geographic position of each node in a plurality of nodes within a data network, for determining an icon to represent each node in the plurality of nodes, for determining node connectivity, and for combining the geographic position, icon and node connectivity into formatted information; and
a visualization computer for using the formatted information to overlay each of the icons onto a geographically accurate map, where each icon is position at the geographic position for the node represented by the icon and for overlaying, upon the geographically accurate map, a graphical link between pairs of icons representing node connectivity.

17. A system for visualizing a data network comprising:
a data network comprising a plurality of nodes, where each node comprising a position location device;
a visualization tool, coupled to the data network, for receiving a position for each node in the plurality of nodes from the position location device, and for displaying at least one icon representing a node at a geographic position upon a geographically accurate map.

18. The system of claim 17 wherein the position location device is a global navigation satellite system (GNSS) receiver.

19. The system of claim 17 wherein the nodes report connectivity information to the visualization tool and the visualization tool displays graphical links between pairs of nodes in response to the connectivity information.

20. The system of claim 17 wherein the nodes report node information to the visualization tool and the visualization tool displays the node information upon a user selecting an icon representing a node.
